(19) United States
(12) Patent Application Publication
(10) Pub. No.: US 2020/0302076 A1
(43) Pub. Date: Sep. 24, 2020

(54) DOCUMENT PROCESSING APPARATUS AND NON-TRANSITORY COMPUTER READABLE MEDIUM

(71) Applicant: FUJI XEROX CO., LTD., Tokyo (JP)

(72) Inventor: Kenichi NUMATA, Kanagawa (JP)

(73) Assignee: FUJI XEROX CO., LTD., Tokyo (JP)

(21) Appl. No.: 16/534,351

(22) Filed: Aug. 7, 2019

(30) Foreign Application Priority Data
Mar. 20, 2019 (JP) 2019-053044

(51) Int. Cl. G06F 21/62; G06K 9/00; G06F 17/21; G06F 3/0484; G06F 17/24

(52) U.S. Cl. CPC G06F 21/6218; G06K 9/00442; G06F 17/24; G06F 3/0484; G06F 17/212

(57) ABSTRACT

A document processing apparatus includes a division unit and a determination unit. The division unit is configured to divide a document into plural partial structures. The determination unit is configured to determine, for each partial structure, whether content of the partial structure includes an element corresponding to a predetermined concealment type, determine that a partial structure which does not include an element corresponding to the concealment type is releasable, and determine that a partial structures which includes an element corresponding to the concealment type is unreleasable.

### CROSS-REFERENCE TO RELATED APPLICATIONS

This application is based on and claims priority under 35 USC 119 from Japanese Patent Application No. 2019-053044 filed Mar. 20, 2019.

### BACKGROUND

### (i) Technical Field

The present disclosure relates to a document processing apparatus and a non-transitory computer readable medium.

### (ii) Related Art

A system is known which analyzes the contents of a document to determine whether the document is classified as confidential, and controls whether to release the document according to the determination.

For example, in an apparatus described in JP-A 2006-209649, a document reference unit refers to the document stored in a document storage unit, and an area division unit divides the document into partial areas such as a header, a text, and a footer. A feature element detection unit extracts a feature element from the partial area with reference to a feature definition dictionary corresponding to the partial area for each partial area, and designates a candidate of a confidential information category into which the partial area may be classified. A correlation evaluation unit quantitatively evaluates the arrangement state of the feature element according to the category for each candidate confidential information category, and determines which confidential information category the partial area is classified into. A confidential information classifying unit determines which confidential information category the document is classified into, based on the confidential information category into which each partial area is classified and the importance of each confidential information category, and determines the importance of the document.

### SUMMARY

In a system of controlling whether documents are releasable or unreleasable in units of documents, even when a document that is determined to be unreleasable includes a portion that is releasable, the portion is not released.

Aspects of non-limiting embodiments of the present disclosure relate to increasing releasable content of a document as compared with a system that controls whether documents are releasable or unreleasable in units of documents.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a document processing apparatus including: a division unit configured to divide a document into plural partial structures; and a determination unit configured to determine, for each partial structure, whether content of the partial structure includes an element corresponding to a predetermined concealment type, determine that a partial structure which does not include an element corresponding to the concealment type is releasable, and determine that a partial structures which includes an element corresponding to the concealment type is unreleasable.

### BRIEF DESCRIPTION OF THE DRAWINGS

Exemplary embodiments of the present disclosure will be described in detail based on the following figures, wherein:

FIG. 1 is a diagram exemplifying a functional configuration of a document processing apparatus;

FIG. 2 is a diagram exemplifying a procedure of a process executed by the document processing apparatus;

FIG. 3 is a diagram illustrating an example of a document registration screen;

FIG. 4 is a diagram exemplifying a determination result screen showing that a partial structure includes information to be concealed;

FIG. 5 is a diagram exemplifying a determination result screen showing that a partial structure does not include information to be concealed;

FIG. 6 is a diagram exemplifying a determination result screen when information to be concealed is found in an image;

FIG. 7 is a diagram exemplifying a functional configuration of the document processing apparatus including a processing unit that processes an element to be concealed;

FIG. 8 is a diagram exemplifying a procedure of a process executed by the document processing apparatus of FIG. 8; and

FIG. 9 is a diagram exemplifying a determination result screen when an element to be concealed is processed.

### DETAILED DESCRIPTION

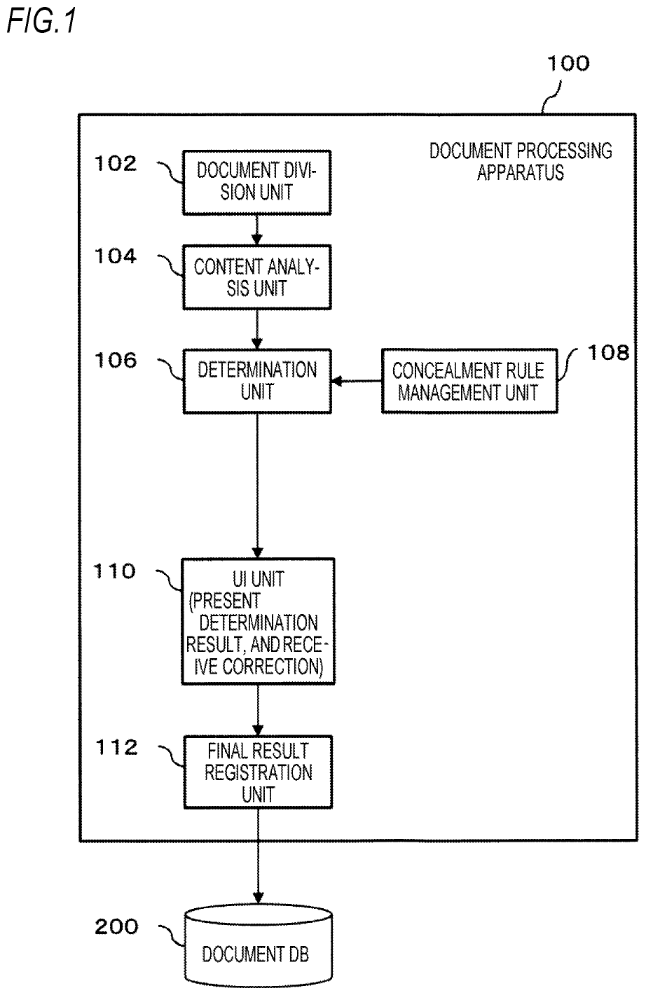

A document processing apparatus 100 according to the present exemplary embodiment will be described with reference to FIG. 1.

The document processing apparatus 100 includes a document division unit 102, a content analysis unit 104, a determination unit 106, a concealment rule management unit 108, a UI unit 110, and a final result registration unit 112.

The document division unit 102 divides an input document into partial structures included in the document.

The document is data of a certain data format, and the data format is not limited. The document may be, for example, any of text data, photographic images, drawings, voice data, moving image data, and document data that may include various types of elements created by various applications such as word processors and spreadsheets.

Further, the partial structures are components that constitute the document. That is, one document includes plural partial structures that do not overlap with each other. When a document includes plural pages, each page may be treated as a partial structure. In addition, when a document has a logical structure such as “chapters, clauses, and sections” or “chapters, articles, sections, and items”, structure elements at a specific level (for example, a paragraph level, a section level, etc.) in the logical structure may be treated as partial structures. For a document whose structure is clearly specified by markup, such as a hypertext markup language (HTML) document, elements separated by markup are examples of partial structures. Further, in a document that is created by a word processing application and contains various objects such as text, images, figures, and moving images, the individual objects are examples of partial structures.

Each partial structure of the division result includes one or more content elements. The document division unit 102 inputs each partial structure of the division result to the content analysis unit 104.

The content analysis unit 104 analyzes content of the input partial structures to divide the content thereof into individual content elements. When the partial structure is a text, content elements are, for example, words. Also, when the partial structure is an image, content elements are individual image elements included in the image. Examples of the image elements include graphics of vector expressions, and images of individual subjects included in a photographic image such as a face and a signboard. Further, when the partial structure is voice data, for example, each word included in a text that is obtained by converting the voice data into the text by voice recognition, is treated as a content element. In addition, when the partial structure is a moving image, images of individual frames that constitute the moving image may be treated as content elements.

The content analysis unit 104 also specifies, for each content element, a type thereof. When the content is text data, the type of content element includes a part of speech, a detailed classification of a part of speech, various identification numbers, a numeric expression, and the like. For example, the detailed classifications of a noun include a general noun and a proper noun. The proper noun include a person's name, a name of an organization such as a company, and the like. The part of speech and the detailed classification of the part of speech may be identified using a dictionary. In addition, examples of the types also include types of identification information that may be recognized from types of characters constituting a character string and the arrangement pattern of the characters. Here, examples of the character string include telephone numbers, uniform resource locators (URLs), and user identification information (user IDs) of social networking services (SNSs). Similarly, examples of the type also include a numeric expression whose meaning may be recognized from a number and a character string attached to the front or back of the number, such as a monetary amount (for example, “yen” or “v”). Further, when the content of the partial structure is an image, examples of types of content elements include a “face” of a person, a “character string” such as a license plate of a car and a signboard, a car, a road, a house, and the like. For a type specification process in the content analysis unit 104, any existing or later developed technology may be used.

The type of the content element obtained by the content analysis unit 104 is used to determine whether the content element corresponds to a target to be concealed. The content analysis unit 104 inputs, for each partial structure, data of content of the partial structure and information on the type of each content element in the partial structure to the determination unit 106.

The determination unit 106 determines whether the partial structure is releasable based on the information on the type of each content element in the partial structure, which is input from the content analysis unit 104. The determination unit 106 is an example of a determination unit. The determination of the determination unit 106 is performed based on concealment rules managed by the concealment rule management unit 108. The concealment rules are information that specifies a concealment type, that is, a type to be concealed among the types of content elements. For example, the concealment rules may include a concealment rule that a person's name, an organization name, an amount of money, a telephone number, and a user ID in text data are of a concealment type. In addition, the concealment rules may include a concealment rule that the face of a person and a character string in an image are of a concealment type.

The determination unit 106 determines whether the type of each content element in the partial structure is a concealment type based on the concealment rules managed by the concealment rule management unit 108. Then, in an example, when the partial structure includes even at least one content element of the concealment type, the determination unit 106 determines that the partial structure is “unreleasable”. Conversely, when the partial structure includes no content element of the concealment type, the determination unit 106 determines that the partial structure is “releasable”.

Here, the determination method determines that a partial structure is unreleasable when the partial structure includes a content element of the concealment type, otherwise determines that the partial structure is releasable. It should be noted that this determination method is merely an example. Instead, a determination may be made based on a more detailed concealment rules. For example, a level may be introduced into the concealment type to make a determination based on the level. For example, the following determination method may be employed. That is, the determination method determines that a partial structure is unreleasable when the partial structure includes even at least one content element of a high-level concealment type. The determination method also determines that a partial structure is unreleasable when the partial structure includes content elements of a low-level concealment type the number of which is equal to or more than a predetermined threshold value which is equal to or more than 2.

The determination unit 106 transmits, for each partial structure included in the document, data of the content of the partial structure and the determination result of releasability of the partial structure, to the UI unit 110. Further, when determining that the partial structure is unreleasable, the determination unit 106 further transmits, to the UI unit 110, information indicating the content element of the partial structure determined to correspond to the concealment type and the type of the content element.

The user interface (UI) unit 110 presents a UI screen group showing the determination result of the determination unit 106 to a document manager (that is, a person in charge of managing release of documents). The UI unit 110 is an example of a presentation unit configured to present, to a user, a screen showing the determination result and receive a change to the determination result from the user, that is, the document manager. The UI screen group presented by the UI unit 110 includes a screen for receiving a correction to the determination result of the releasability of the partial structure from a document manager. The document manager, for example, accesses the document processing apparatus 100 from his/her terminal, confirms the determination result of the determination unit 106 through the UI screen group presented by the UI unit 110, and corrects the determination result as necessary. Detailed examples of the presented UI screen group and the user's confirmation work using such the UI screen group will be described later.

The final result registration unit 112 registers a flag to which reflected is a result of the document manager's correction through the UI unit 110 and represents the final determination result of the releasability of each partial structure of the document in a document DB 200 in association with the each structure element.

When a user accesses to a document registered in the document DB 200, the document DB 200 controls, for each partial structure of the document, whether to release the partial structure to the user according to a releasability flag associated with the partial structure. For example, the document DB 200 provides the user with data of partial structures associated with a releasable flag and does not provide the user with data of partial structures associated with an unreleasable flag.

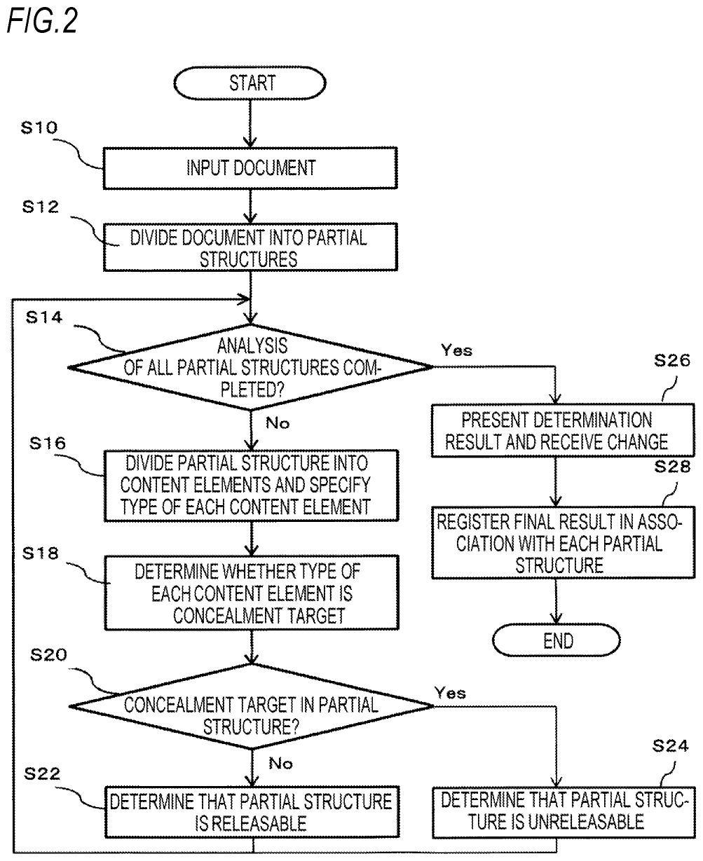

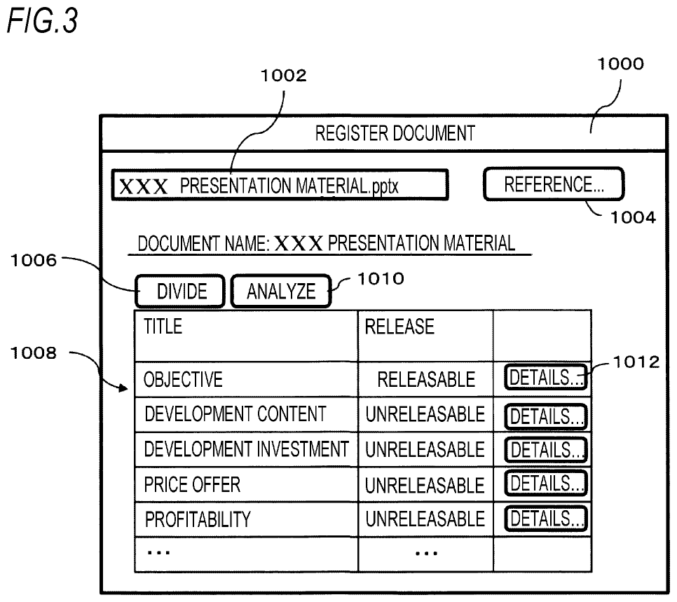

Next, an example of a process procedure executed by the document processing apparatus 100 will be described with reference to FIG. 2. Further, in this description, examples of the UI screen illustrated in FIGS. 3 to 6 will be referred to as appropriate.

First, the document manager inputs a document to be processed to the document processing apparatus 100 (S10). For example, the document processing apparatus 100 presents a document registration screen 1000 illustrated in FIG. 3 to the document manager who has logged in. The document registration screen 1000 has a field 1002 to which identification information on a target document is input. The document manager inputs identification information on the document to be processed to the field 1002. In this input operation, the document manager may call a network file system by pressing a reference button 1004, find and select the file of the target document by operating the network file system, and input the file to the field 1002.

Next, the document division unit 102 divides the document to be processed into partial structure units according to an instruction from the document manager. For example, when the document manager presses the “divide” button 1006 in the document registration screen 1000 illustrated in FIG. 3, the document division unit 102 divides the document into partial structures. The result of division is displayed in a document structure display field 1008. The document structure display field 1008 displays, for each partial structure included in the document, a title of the partial structure and a releasability flag (entitled “release” in the drawing). The title of the partial structure is generated, for example, from the heading of the partial structure, the word at the beginning of the partial structure, or the like. The releasability flag indicates the determination result on the releasability of the document. At the stage of dividing the document into partial structures, a value of the releasability flag has not yet been determined.

Next, the document processing apparatus 100 repeats analysis of a partial structure (S14 to S24) until analyzing all partial structures in the document. This analysis process is started, for example, by the document manager pressing an “analyze” button 1010 in the document registration screen 1000.

In this analysis process, the document processing apparatus 100 first determines whether the analysis process has been completed for all partial structures in the document (S14). Then, when it is determined that the analysis process has not been completed for all partial structures, one unprocessed partial structure is picked up so as to cause the content analysis unit 104 to analyze the partial structure. The content analysis unit 104 divides the partial structure to be analyzed into content elements, and specifies, for each content element, the type of the content element (S16).

Next, the determination unit 106 determines, for each content element in the partial structure, whether the type of the content element corresponds to a concealment target (S18). Then, the determination unit 106 determines whether the partial structure includes a content element determined to be a concealment type (S20). When the result of this determination is “No”, that is, when the partial structure includes no content element of the concealment type, the determination unit 106 determines that the partial structure is releasable (S22). Meanwhile, when the determination result in S20 is “Yes”, that is, when the partial structure includes one or more content elements of the concealment type, the determination unit 106 determines that the partial structure is unreleasable (S24).

The determination method of S20 to S24 in FIG. 2 is merely an example. Any of determinations based on the other determination methods as exemplified above may be made.

The determination result on the releasability of each partial structure by the determination unit 106 is displayed, for example, in the “release” flag field of the document structure display field 1008 of the document registration screen 1000.

When the processes of S16 to S24 are completed for all partial structures in the document, the determination result of S14 becomes “Yes”. Then, the document processing apparatus 100 displays the determination result on the screen, and receives an input of a change from the document manager who is viewing the screen (S26).

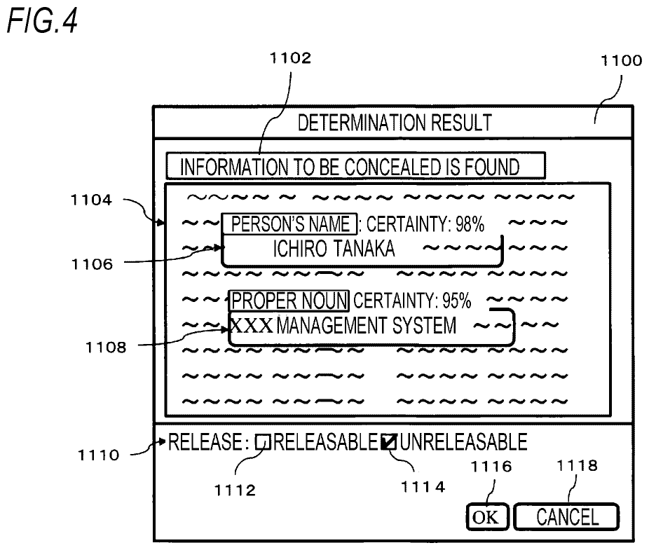

For example, in the document structure display field 1008 of the document registration screen 1000 illustrated in FIG. 3, a “details” button 1012 for confirming the details of a partial structure is provided for each partial structure of the document. The document manager presses the “details” button 1012 for a partial structure that he/she wants to confirm. Then, the document processing apparatus 100 presents, to the document manager, a screen including the content of the partial structure and a UI component that changes the determination result on the releasability. An example of this screen is a determination result screen 1100 illustrated in FIG. 4.

The determination result screen 1100 includes an analysis result display field 1102, a partial structure display field 1104, and a releasability input field 1110.

In the analysis result display field 1102, displayed is a message indicating whether the partial structure displayed on the determination result screen 1100 includes a content element to be concealed. The example illustrated in FIG. 4 relates to a case where a content element of the type to be concealed is found in the partial structure, and a message “information to be concealed is found” is displayed in the analysis result display field 1102.

The partial structure display field 1104 displays the content of the partial structure. FIG. 4 illustrates an example where the partial structure is text data, and the partial structure display field 1104 displays character strings constituting the text. Further, when the entire partial structure cannot be displayed with the size of the partial structure display field 1104, the range displayed in the partial structure display field 1104 is moved by scroll operation.

Then, when the partial structure includes the content element of the type to be concealed, the content element to be concealed is highlighted among the content of the partial structure displayed in the partial structure display field 1104. In the example of FIG. 4, the displayed partial structure includes two content elements 1106 and 1108 to be concealed. In the illustrated example, the content elements 1106 and 1108 to be concealed are highlighted in a framed form. Further, in each frame, the type of the content element and a certainty degree are displayed. For example, the content element 1106 is a character string “Ichiro Tanaka”, the type is a “person's name”, and the certainty degree is “98%”. The certainty degree is a value indicating a degree to which the content analysis unit 104 “believes” that the content element corresponds to that type. In other words, the certainty degree indicates a probability that the analysis result of the content analysis unit 104 that “the content element corresponds to the type” is correct. When the content analysis unit 104 is implemented as a machine learning based device such as a neural network, such a device may have a function of determining the type of a content element and outputting a certainty degree of the determination result. The document manager may use the certainty degree in making a determination. Further, the content element 1108 determined to be a concealment target is a character string “XXX management system”, which is determined to be a proper noun with a certainty degree of 95%.

In the releasability input field 1110, check boxes 1112 and 1114 are displayed that allow the user to select “releasable” or “unreleasable” for the partial structure. When one of the two check boxes 1112 and 1114 is selected (that is, with a check mark), the other is in a non-selected state. At a point in time when the determination result screen 1100 is first displayed after the determination is made by the determination unit 106, a check mark is attached to one of the two check boxes 1112 and 1114 that corresponds to the determination result of the determination unit 106. The document manager reads the content of the partial structure displayed in the partial structure display field 1104 and the content elements 1106 and 1108 to be concealed that are highlighted in the content of the partial structure, and then determines whether (i) to make the partial structure “unreleasable” as determined by the determination unit 106 or (ii) to change the releasability of the partial structure to “releasable”.

For example, when the partial structure includes a person's name or a proper noun, such information needs to be concealed as being similar to personal information in many cases. However, it is not always necessary to conceal such information uniformly only because it is a person's name or a proper noun. For example, when such information is the name of a historical person, it would be ok to release the name. Also, when a certain name refers to the name of a person in public office and the context of an article relates to the public activity of the person, there is no problem to release the name. As described above, even for a partial structure that would be determined to be unreleasable when a determination is made only based on the type of a content element, a human may determine that the partial structure is releasable when reading the content of the partial structure. Therefore, in the present exemplary embodiment, the document manager who is a human is entrusted with a final determination as to whether to release the document.

For example, when the determination unit 106 determines that the document is “unreleasable” and then the document manager confirms the content of the partial structure and determines that the document is to be changed to be “releasable”, the document manager changes the check box 1112 to a selected state by the clicking operation.

When the document manager confirms that the selection state of the releasability represented in the releasability input field 1110 matches his/her final determination, the document manager presses an “OK” button 1116. Accordingly, the final determination result of the releasability is associated with the partial structure. The document registration screen 1000 is presented again to the document manager. When the document manager changes the selection state of the releasability check boxes 1112 and 1114 on the determination result screen 1100 from the state corresponding to the determination result of the determination unit 106, the releasability flag of the partial structure in the document structure display field 1008 of the document registration screen 1000 is changed to a value according to the change.

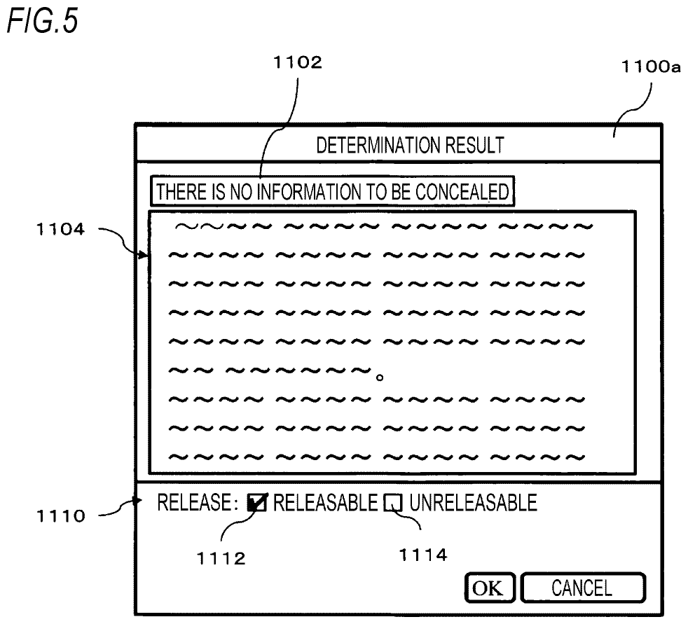

FIG. 5 is a diagram illustrating an example of a determination result screen 1100a for a partial structure that is determined by the determination unit 106 to be releasable. In this example, the analysis result display field 1102 displays a message of the determination unit 106 indicating that “there is no information to be concealed”. Since there is no content element determined to be the concealment target, the partial structure displayed in the partial structure display field 1104 has no highlighted part. In addition, the “releasable” check box 1112 is in a selected state.

Also, in this case, the document manager reads the content displayed in the partial structure display field 1104 and determines whether the releasability of the document remains “releasable”. Then, for example, when determining that there is a need to change, the document manager selects the “unreleasable” check box 1114.

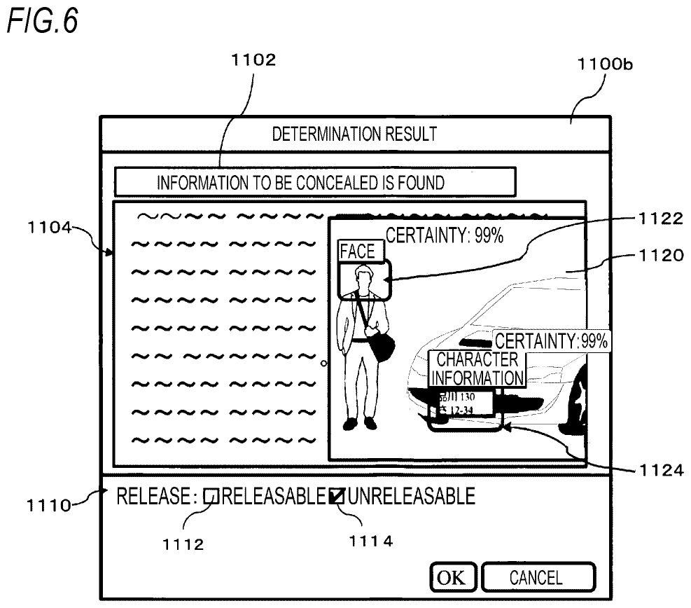

FIG. 6 illustrates a determination result screen 1100b for a partial structure containing an image 1120. The image 1120 includes a face 1122 and character information 1124 (in this example, the registration number of a car) which correspond to the type to be concealed.

In this example, the determination unit 106 determines that the partial structure including the image 1120 is unreleasable. In the display of the partial structure display field 1104, the face 1122 and the character information 1124 in the image 1120 are highlighted by a frame. Also, the display of the partial structure display field 1104 indicates that the former type is a “face” and the latter type is “character information”. The document manager recognizes a portion determined to be concealed in the image 1120, from this display. Further, in consideration of the image content of the portion, the surrounding image, and other contents (for example, text) in the partial structure, the document manager determines whether to approve or change the determination result that the partial structure is unreleasable. When the document manager determines to change, he/she puts a check mark in the check box 1112.

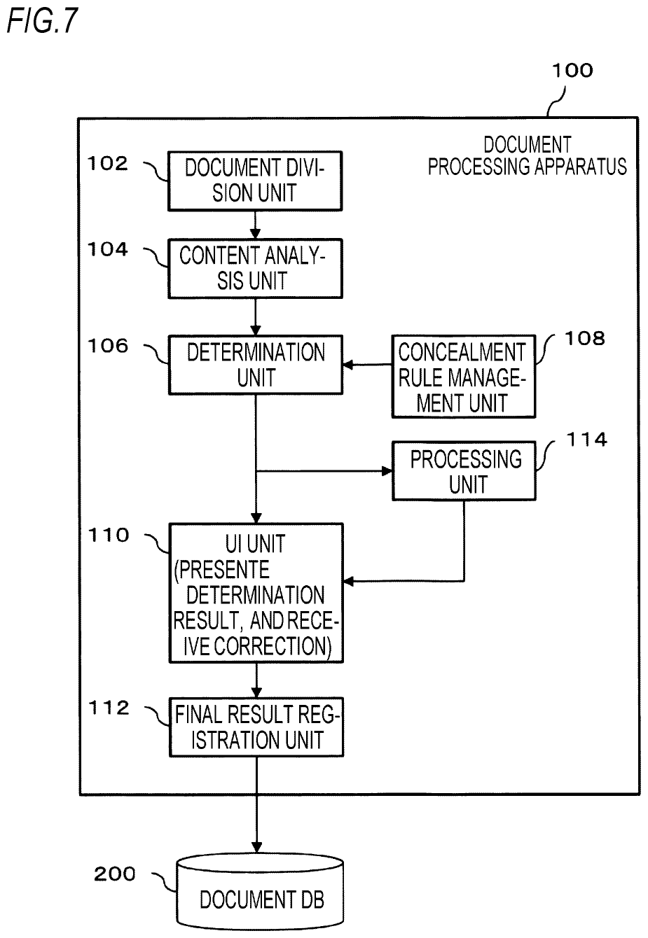

FIG. 7 illustrates a modification of the document processing apparatus 100. The document processing apparatus 100 illustrated in FIG. 7 is obtained by adding a processing unit 114 to the document processing apparatus 100 illustrated in FIG. 1.

The processing unit 114 processes a content element determined by the determination unit 106 to be concealed into data of a releasable expression. The processing unit 114 is an example of a processing unit configured to process an element corresponding to the concealment type into a releasable expression. Any of various masking methods and anonymization methods may be used as a processing method. For example, in this process, the content element determined to be a concealment target is replaced with a black-out image or deleted.

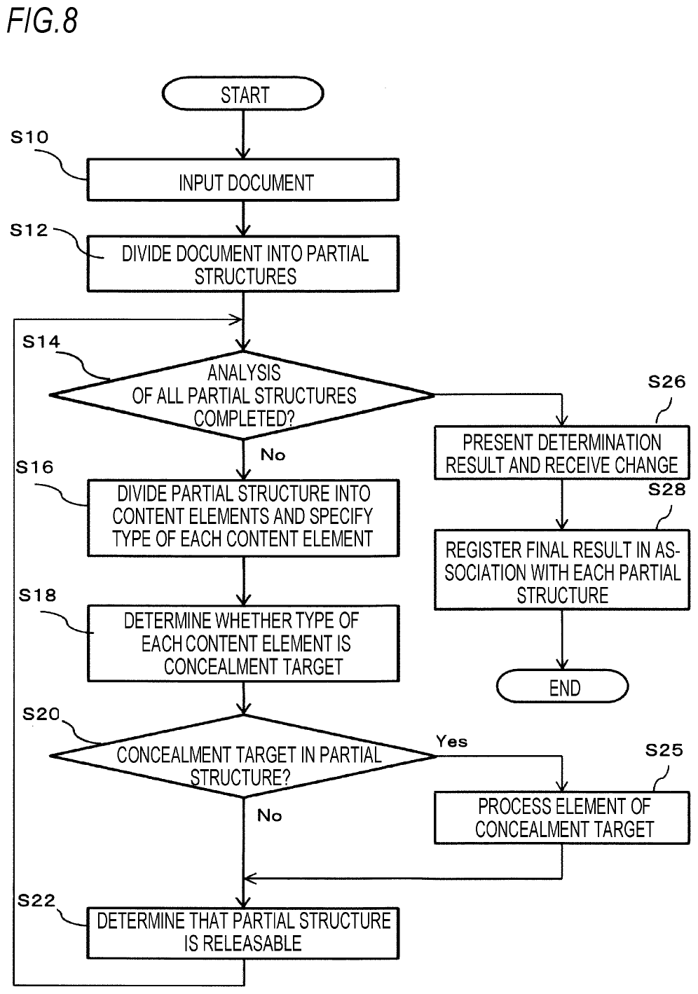

FIG. 8 exemplifies a process procedure executed by the document processing apparatus 100 in this modification. In the procedure of FIG. 8, the same steps as those in the procedure of FIG. 2 are denoted with the same reference numerals, and the descriptions thereof will be omitted.

In the procedure of FIG. 8, when it is determined in S20 that the partial structure includes a content element to be concealed, the processing unit 114 processes the content element to be concealed into data of a releasable expression (S25). Then, the determination unit 106 determines that the processed partial target is releasable (S22).

In the procedure of FIG. 8, the processing unit 114 automatically processes the content element to be concealed in the partial structure. It should be noted that this is merely an example. Instead, a process may be executed according to a process execution instruction from the document manager.

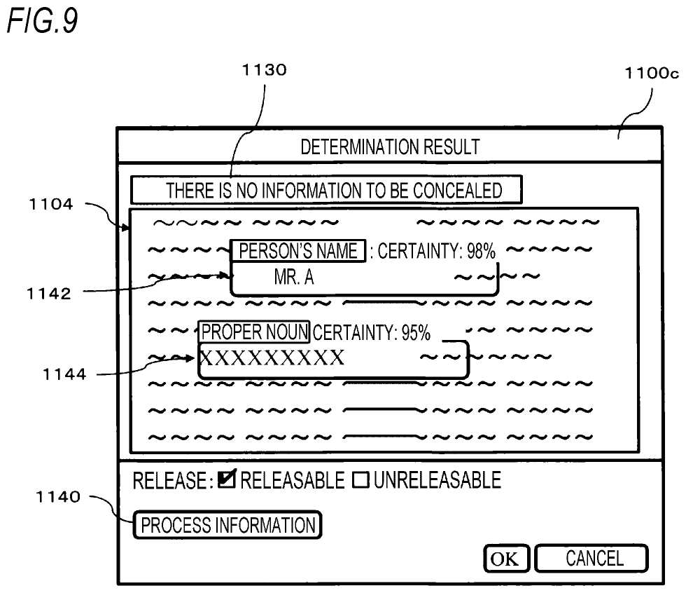

FIG. 9 exemplifies a determination result screen 1100c in this modification. In this example, when the document manager presses “process information” 1140 in the determination result screen 1100c, the processing unit 114 processes each content element to be concealed in the partial structure displayed in the partial structure display field 1104. The content element 1106 determined to be a person's name (see FIG. 4) is processed into a character string “Mr. A” indicating an anonymized person's name. The content element 1108 determined to be a proper noun is processed into a character string obtained by changing each character to “X”. As described above, the processing unit 114 may perform a type of process that is determined in advance for each type of content element to be concealed.

The document processing apparatus 100 described above may be implemented by causing a computer to execute a program representing the function of a group of elements which constitutes the document processing apparatus 100 described above. Here, the computer has a circuit configuration in which a microprocessor such as a CPU, for example, as hardware, a memory (primary storage) such as a random access memory (RAM) and a read only memory (ROM), a controller that controls a fixed storage device such as a flash memory, a solid state drive (SSD), or a hard disk drive (HDD), a network interface that performs a control for connection to networks such as various input/output (I/O) interfaces and local area networks, and the like are connected via, for example, a bus or the like. A program in which the processing content of each of the functions is described is stored in a fixed storage device such as a flash memory via a network or the like, and installed in a computer. The program stored in the fixed storage device is read out to the RAM and executed by a microprocessor such as a CPU, thereby the functional module group exemplified above is implemented.

The document processing apparatus 100 may be configured on a group of computers as described above, or may be configured as a system including plural computers that may communicate with each other. For example, in the exemplary embodiment and the modification described above, the content analysis unit 104 may be removed from the document processing apparatus 100, and instead, an external service providing a function equivalent to the content analysis unit 104 may be used.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document processing apparatus comprising:
a division unit configured to divide a document into plural partial structures; and
a determination unit configured to
determine, for each partial structure, whether content of the partial structure includes an element corresponding to a predetermined concealment type,
determine that a partial structure which does not include an element corresponding to the concealment type is releasable, and
determine that partial structures which includes an element corresponding to the concealment type is unreleasable.

2. The document processing apparatus according to claim 1, further comprising:
a presentation unit configured to
present, to a user, a screen showing a determination result of the determination unit for each partial structure of the document, and
receive a change to the determination result from the user.

3. The document processing apparatus according to claim 2, wherein the presentation unit presents, as the screen, a screen displaying
(i) content of each partial structure of the document, and
(ii) information specifying a portion corresponding to the element corresponding to the concealment type in the content.

4. The document processing apparatus according to claim 2, further comprising:
a processing unit configured to processes the element which corresponds to the concealment type and which is included in the content of each partial structure of the document, into a releasable expression, wherein
the presentation unit
presents the content of each partial structure of the document processed by the processing unit a determination result indicating that its content is releasable side by side, and
receives a change to the determination result from the user.

5. A non-transitory computer readable medium storing a program that causes a computer to execute a document process, the document process comprising:
dividing a document into plural partial structures;
determining, for each partial structure, whether content of the partial structure includes an element corresponding to a predetermined concealment type;
determining that a partial structure which does not include an element corresponding to the concealment type is releasable; and
determining that a partial structures which includes an element corresponding to the concealment type is unreleasable.

6. A document processing apparatus comprising:
division means for dividing a document into plural partial structures; and
determination means for
determining, for each partial structure, whether content of the partial structure includes an element corresponding to a predetermined concealment type,
determining that a partial structure which does not include an element corresponding to the concealment type is releasable, and
determining that a partial structures which includes an element corresponding to the concealment type is unreleasable.
